(19) United States
(12) Patent Application Publication
(10) Pub. No.: US 2006/0078656 A1
(43) Pub. Date: Apr. 13, 2006

(54) Ready-to-use bottle liners containing premeasured amount of infant formula and methods of making the same

(75) Inventors: Paul B. Manning, Troy, VA (US); Adam P. Burke, Williamsburg, VA (US); James W. McGrath JR., Keswick, VA (US)

Correspondence Address: NIXON & VANDERHYE, PC, 901 NORTH GLEBE ROAD, 11TH FLOOR, ARLINGTON, VA, 22203, US

(73) Assignee: PBM PRODUCTS, Inc., Gordonsville, VA (US)

(21) Appl. No.: 10/974,962

(22) Filed: Oct. 28, 2004

Related U.S. Application Data
(60) Provisional application No. 60/616,222, filed on Oct. 7, 2004.

(51) Int. Cl. A61J 9/00; A21D 10/02; B65D 85/00

(52) U.S. Cl. 426/117; 215/11.3

(57) ABSTRACT

Flaccid baby bottle liners have a premeasured amount of sterilized powdered infant formula that is ready for use when desired.

### CROSS-REFERENCE TO RELATED APPLICATION

The present application is based on, and claims domestic priority benefits under 35 USC § 119(e) from, U.S. Provisional Patent Application Ser. No. 60/616,222 filed on Oct. 7, 2004 (Atty. Dkt. No. 3870-55), the entire content of which is expressly incorporated hereinto by reference.

### FIELD OF THE INVENTION

The present invention relates generally to the field of infant feeding. In especially preferred forms, the present invention is embodied in shelf-stable open-ended flaccid liners having a premeasured amount of infant formula that is ready for use when desired.

### BACKGROUND AND SUMMARY OF THE INVENTION

A mother's breast milk is widely recognized as being significantly important to a nursing infant's nutrition and general health. A substantial problem with breast feeding, however, is that once the breast milk is expressed it must be used essentially immediately. The breast milk may, however, be frozen which increases its shelf life, but such a task usually entails the excessive handling of the breast milk requiring transfer from the collection container, to a freezing container, and then to the final feeding container. In addition, there are sometimes physical problems with the child and/or the child's mother that prevents nursing. As a result, infant formula has been widely used for its convenience and nutritional value as a supplement for, or a total replacement of, mother's breast milk.

There still exist several issues with respect to infant formula. For example, powdered infant formula is not a sterile product. As such, it has a limited shelf life. Moreover, powdered infant formula is typically provided in bulk containers and so must be introduced into the baby bottle at the point of use.

It would therefore be highly desirable if flaccid baby bottle liners could be provided having a premeasured amount of infant formula (e.g., in either powdered, liquid concentrate or ready-to-feed form) that is available for use when desired. It is toward fulfilling such a need that the present invention is directed.

Broadly, the present invention is embodied in flaccid baby bottle liners having a premeasured amount of infant formula therein. It is especially preferred that a blanket of inert gas be present over the premeasured amount of infant formula contained within the baby bottle liners. Most preferably, the ready-to-use baby bottle liners in accordance with the present invention and the premeasured amount of powdered, liquid concentrate or ready-to-feed infant formula therein is sterilized. By the term “sterilized” is meant that less than 1 non-sterile unit is present per 10³ sterile units, more preferably less than 1 non-sterile unit per 10⁶ sterile units, according to one or more of Association for the Advancement of Medical Instrumentation (AAMI) Standards 11137; TIR17; 11737-1; 11737-2; TIR22 and/or 11607 (the entire content of each being expressly incorporated hereinto by reference).

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1 is a perspective view, partly in section, of an especially preferred embodiment of a ready-to-use baby bottle liner having a premeasured amount of infant formula therein;

FIG. 2 is a perspective view, partly in section, of a product configuration having a plurality of the ready-to-use baby bottle liners as shown in FIG. 1;

FIG. 3 is a perspective view of an alternative embodiment of the ready-to use baby bottle liner in accordance with the present invention; and

FIG. 4 is a schematic representation of preferred process steps for making a product package containing a plurality of read-to-use baby bottle liners in accordance with the present invention.

### DETAILED DESCRIPTION OF THE INVENTION

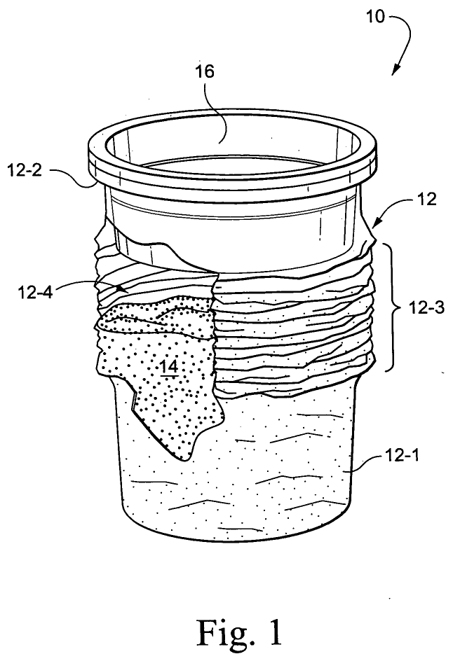

Accompanying FIG. 1 shows one presently preferred embodiment of a ready-to-use prefilled flexible baby bottle liner 10 in accordance with the present invention. In this regard, the liner 10 of the present invention will necessarily include a flexible liner component 12 which unitarily includes a flaccid elongate body portion 12-1 having a closed bottom, and an open-ended top defined by a self-supporting and shape-retaining annular flange member 12-2.

By the term “self-supporting” is meant that the structure is capable of supporting its own weight against gravity without deformation. Thus, the flaccid body portion 12-1 is non-self-supporting since it is incapable of supporting its own weight against gravity. The term “shape retaining” means that the structure is capable of retaining and/or resiliently returning to its original shape after the application of a deformation force. Thus, the flange member 12-2 of the liner is yieldable to a deformation force, but is sufficiently pliant and resilient to return substantially to its originally annular shape after the deformation force is released.

A premeasured quantity of infant formula 14 is placed in the liner body portion 12-1 and occupies the lower extent thereof. In this regard, although reference has been and will hereinafter be made to powdered infant formula, it will be appreciated that the infant formula may also be in the form of a liquid concentrate. In either case, additional water will be added to the infant formula prior to feeding. Moreover, according to at least one embodiment of the present invention, it is entirely possible that the formula could be ready-to-feed (i.e., non-concentrated). Thus, for ease of discussion, the infant formula will hereinafter be referenced as powdered, but such a reference is non-limiting to the scope of the present invention.

In addition, reference will be hereinafter made to the formula 14 being sterilized. However, while sterilization of the infant formula is presently preferred, the present invention may likewise be embodied with formula 14 which is not sterilized. For example, the formula could include a chemical stabilizer and/or be stabilized physically such as, for example, by being refrigerated or frozen. Accordingly, reference to a sterilized infant formula being contained within the liner is to a presently preferred embodiment thereof which is non-limiting to the present invention.

As can be seen in FIG. 1, the body portion 12-1 of the liner is in a partially collapsed state so as to reduce its overall axial length and thereby reduce the space needed for packaging, storage and/or transport. More particularly, in the embodiment depicted in FIG. 1, the body portion 12-1 of the liner has a collapsed region 12-3 formed of a series of accordion style pleats. While in such a partially collapsed state, the open end of the liner 12 defined by the flange 12-2 may be sealed with a suitable cap 16. In this regard, the cap 16 may advantageously be the type as disclosed in co-pending, commonly owned U.S. Patent Publication No. US-2004-0122356A1, the entire content of which is incorporated fully hereinto by reference. Alternatively (or additional) the open liner end defined by the flange 12-2 may be sealed by a suitable plastics film or metallic foil.

Since the liner body portion 12-1 is partially collapsed, a small interior space 12-4 will exist between the quantity of powdered infant formula 14 and the cap 16. The interior space 12-4 is most preferably substantially deoxygenated so as to prolong the shelf life of the powdered infant formula 14 contained with in the liner 12. More particularly, the interior space 12-4 may be filled with a suitable inert gas (e.g., nitrogen, argon, carbon dioxide or the like) or may be evacuated. Alternatively, the interior space 12-4 may be evacuated (e.g., a vacuum) which would then also serve the beneficial function of assisting to maintain the liner body portion 12-1 in its partially collapsed state as shown.

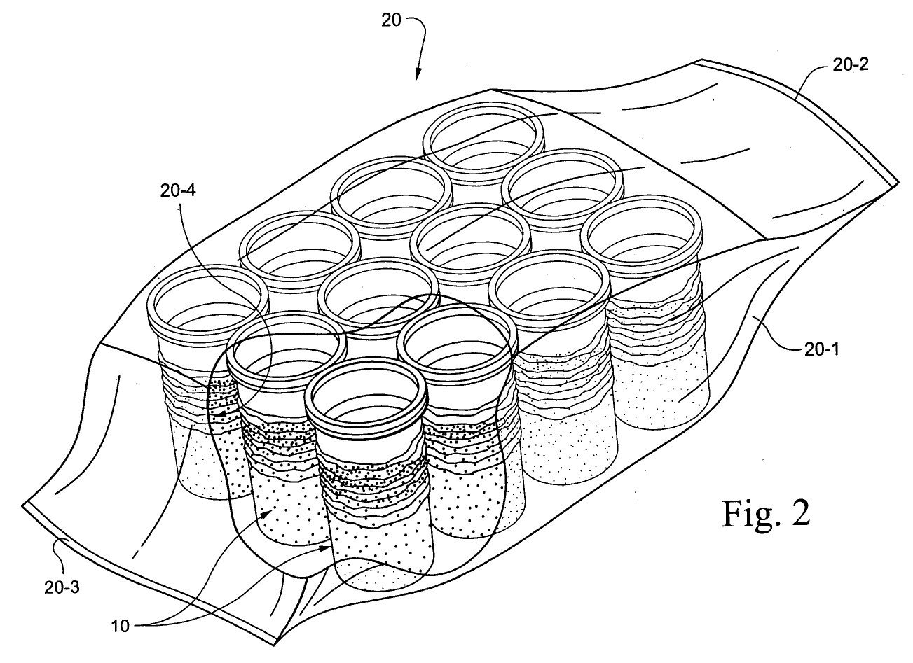

One possible form of a package 20 containing a plurality of the ready-to-use prefilled flexible baby bottle liners 10 as described previously is shown in accompanying FIG. 2. The package 20 therefore provides consumers with an available supply of such ready-to-use prefilled flexible baby bottle liners 10. As shown, the package 20 is formed of a pouch 20-1 of suitable packaging material which is sealed at each of its ends 20-2, 20-3 so as to surroundingly entrap the prefilled baby bottle liners 10. In this regard, the interior space 20-4, similar to the liner space 12-4 described above, is most preferably filled with a suitable inert gas (e.g., nitrogen, argon, carbon dioxide or the like) or may be evacuated. Alternatively, the interior space 20-4 could be evacuated (e.g., a vacuum) so that the prefilled baby bottle liners 10 are maintained in a substantially deoxygenated environment within the package 20.

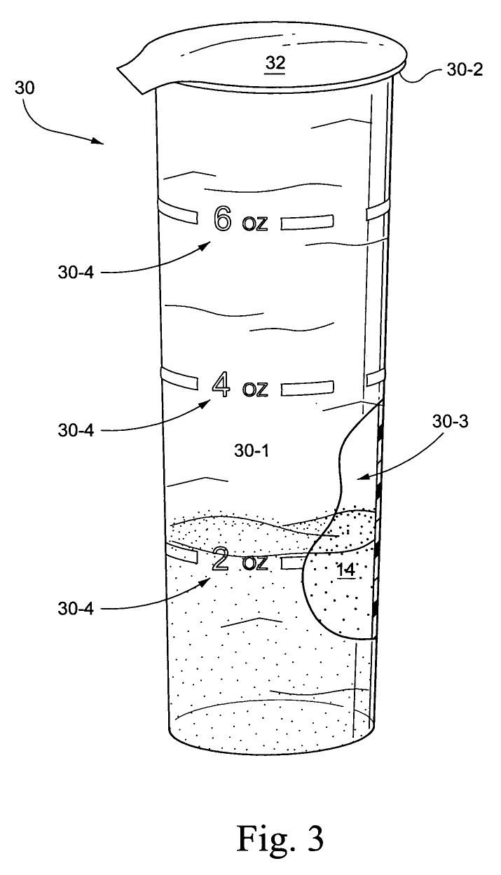

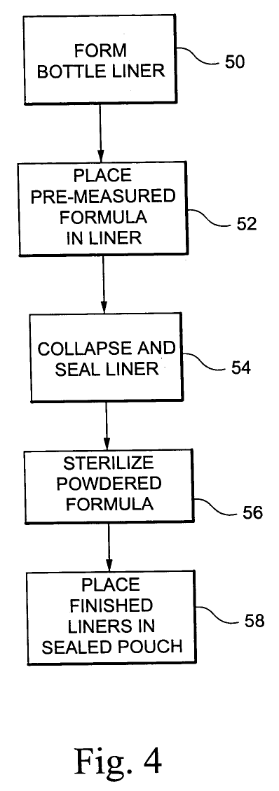

Another preferred embodiment of a read-to-use prefilled baby bottle liner 30 in accordance with the present invention is depicted in accompanying FIG. 3. In this regard, as compared to the embodiment of the prefilled liner 10 described previously, the prefilled liner 30 in accordance with the embodiment shown in FIG. 4 is not partially collapsed, but instead is extended its full axial length. Similar to the liner 10, however, the liner 30 unitarily includes a flaccid elongate body portion 30-1 having a closed bottom, and an open-ended top defined by a self-supporting and shape-retaining annular flange member 30-2. A quantity of powdered infant formula 14 occupies the bottom region of the liner body portion 30-1. A plastics film or metallic foil seal 32 covers the open end of the liner body 30-1 defined by the flange member 30-2 and may be removeably attached thereto by means of any suitable adhesive.

The interior space 30-3 is most preferably filled with an inert gas (e.g., nitrogen, argon, carbon dioxide or the like). In the embodiment depicted in FIG. 3, it is typically not suitable to evacuate the interior space 30-3 as it would cause the liner body 30-1 to collapse. Thus, by filling the interior space 30-3 with an inert gas to a pressure slightly greater than atmospheric, the entire liner body 30-1 will be resistant to crushing (e.g., due to the cushioning effect caused by the inert gas-filled interior space 30-3) thereby allowing the user to more easily handle and manipulate the same (e.g., to allow greater ease of loading of a rigid baby bottle outer sleeve prior to use).

The embodiment of the prefilled baby bottle liner 30 in accordance with the present invention depicted in accompanying FIG. 3 is also especially well suited for containing premeasured amounts of ready-to-feed infant formula (i.e., instead of infant formula in a powdered or liquid concentrate form). Thus, the prefilled baby bottle liner 30 may be refrigerated or frozen with such ready-to-feed infant formula therein for the purpose of transport and ultimate consumer sales.

Although an exemplary product package containing a number of prefilled liners 30 is not shown, it is envisioned that such liners 30 may be placed in a relatively rigid holder (e.g., similar to the type shown in the above-referenced co-pending, commonly owned U.S. Patent Publication No. US-2004-0122356 A1) and then placed in a sealed pouch similar to that shown in FIG. 2 and described above.

The liner 30 may also be provided with measurement markings 30-4 either printed on or embossed into the liner body portion 30-1 thereof so as to assist the end user to determine the proper amount of water is added to the powdered or diluted infant formula and thereby ensuring the proper concentration.

Any material suitable for use as a baby bottle liner containing infant formula in both its dehydrated (powdered) and hydrated (liquid) forms may be employed to form the liners 12 and 30 of the present invention. Virtually any sheet-formable thermoplastics material may be employed in the practice of this invention, including (but not limited to) polymers and copolymers of polyolefins (such as polypropylenes, polyethylenes and the like), polyesters, polyamides (e.g., nylons), polyphenylene oxides, polyphenylene sulfides, polyvinyl chlorides, acrylonitriles and the like. Blends of such thermoplastics materials may also be employed in any desired blend ratio to suit desired end use applications. In addition, metal foils, e.g., aluminum, may also be employed in the practice of the present invention. Particularly preferred for the ultimate fabrication of containers for use in the present invention are food grade polyolefins, with polyethylenes being particularly preferred.

It is especially desirable that the material forming the liners 12 and 30, and especially their respective flexible liner bodies 12-1 and 30-1, should formed of a food grade material having oxygen barrier properties. By the term “oxygen barrier” is meant a material that exhibits an oxygen permeability according to ASTM D-1434 of less than about 0.010, preferably less than about 0.005, and most preferably less than 0.003 cc.mil/100 in²/24 hrs./atm. at 65% relative humidity (RH) and 68° F. Such oxygen barrier materials along with the inert gas-filled interior space, will ensure that the powdered infant formula contained in the liners will be subjected to a substantially oxygen free (i.e., less than about 1.5% O₂) environment thereby prolonging its shelf life.

The oxygen barrier materials may be a thermoplastics material or may be a metal foil. A metallized layer on thermoplastics material is also envisioned so as to achieve the desired oxygen barrier properties. The liners 10 and 30 may thus be formed of a monolayer of an oxygen barrier material per se, or may be multiple layers of materials wherein one or more such layers are oxygen barrier materials and one or more other layers are formed of non-oxygen barrier materials. Suffice it to say, that the selection of any particular oxygen barrier material is dependent upon a number of factors, including the desired container properties and its end use application.

Exemplary classes of oxygen barrier thermoplastics materials include ethylene vinyl alcohol (EVOH) copolymers (e.g., commercially available from Eval Company of America under the registered trademark EVAL®), polyvinylidene chlorides (e.g., commercially available from Dow Chemical under the registered trademark SARAN®), oriented and non-oriented polyamides (e.g., nylon 6), and oriented polyesters.

One particularly preferred multilayer thermoplastic film that may be employed in the practice of the present invention is disclosed in U.S. Pat. No. 6,093,462, the entire content of which is expressly incorporated hereinto by reference.

Most preferably the pouch 12-1 which is shown above in the product package 20 is also formed of an oxygen barrier material. Therefore, by packaging the individual prefilled baby bottle liners within an oxygen barrier packaging material, further shelf life properties may be achieved.

In use, one of the prefilled baby bottle liners 10 or 30 may be removed from its product package and transported as needed by the user. When it is time to feed a baby, the user may simply remove the cap structure 16 or 32 and fill the interior of the liner 10 or 30 with the proper amount of water, preferably heated to a proper ingestion temperature. In this regard, a fill line may be printed, embossed or otherwise visually indicated on the liner body 12-1 or 30-1, respectively, to aid the user. Once the powdered formula has been dissolved, the user may place the now liquid-filled liner 10 or 30 into a tubular bottle sleeve, and cap the sleeve and liner with an appropriate feeding nipple, following which the formula may be given to the baby.

Accompanying FIG. 4 shows schematically a sequence of process steps that may be employed to form the prefilled liners 10 or 30 described previously. In this regard, the flexible baby bottle liners may first be made in step 50. Most preferably, the flexible liners 12 and 30 may be made as described more fully in U.S. Pat. Nos. 4,836,764, 4,836,764 and 5,091,231, the entire content of each being incorporated hereinto by reference. Thereafter, in step 52, a premeasured amount of powdered infant formula is placed in the formed liners and then sealed in step 54. If a partially collapsed liner as shown, for example, in FIG. 1 is being made, then the liner body 12-1 may be partially collapsed in step 54 by suitable mechanical means.

The powdered baby formula may be subjected to sterilization in step 56, preferably by means of gamma or electron beam irradiation so that the premeasured infant formula 14 is sterilized. In this regard, powdered infant formula is not currently produced as a sterile product and therefore routinely contains low levels of microorganisms. The infant formula is, however, routinely tested for potential contamination with pathogenic organisms (e.g., Coliforms, Slamonella, Listeria, yeast, mold and Enterobacteriaceae family of bacteria, including E. sakazakii). Occasionally, such tests are positive resulting in the batch of infant formula being discarded. However, even if negative, the current tests only provide a relatively low level of statistical assurance that the infant formula is free of pathogenic contaminants. Sterilizing the infant formula in the prefilled liners 10 or 30 according to the present invention by means of gamma or electron beam radiation will therefore ensure that the infant formula is aseptic.

Thereafter, in step 58, a plurality of the sealed prefilled flexible baby bottle liners 10 or 30 may be packaged for commercial distribution in the manner as described above.

It will be appreciated that steps 52, 54 and 58 are most preferably practiced under a “blanket” of inert gas (e.g., nitrogen, argon, carbon dioxide or the like). In such a manner, the interior spaces of the baby bottle liners and product packages will be filled with the inter gas thereby prolonging the shelf life of the contained powdered infant formula. Moreover, during the filling step 54, inert gas may be percolated through a bulk supply of the powdered infant formula so as to assist in purging the same of air.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope thereof.

What is claimed is:

1. A ready-to-use sealed baby bottle liner having a premeasured amount of infant formula contained therein.

2. The baby bottle liner of claim 1, wherein the infant formula is sterilized.

3. The baby bottle liner of claim 1, wherein the infant formula is contained within the liner in an inert atmosphere.

4. The baby bottle liner of claim 3, wherein the inert atmosphere within the liner is at a pressure which is greater than atmospheric pressure.

5. The baby bottle liner of claim 1, wherein the liner is in a partially collapsed condition.

6. The baby bottle liner of claim 5, wherein the infant formula is contained within the liner in a substantial vacuum.

7. The baby bottle liner of claim 1, wherein the infant formula is in the form of a powder, a liquid concentrate or ready-to-feed.

8. The baby bottle liner of claim 1, wherein the liner is comprised of a flaccid body portion having an open upper end and a closed bottom, and a shape-retaining annular flange member at said open upper end thereof.

9. A ready-to-use baby bottle liner comprising a partially collapsed flaccid liner body having an open upper end and a closed bottom end, a premeasured amount of infant formula contained within a portion of the partially collapsed liner body at the closed bottom end thereof, and a seal covering the open end of the liner body.

10. The bottle liner as in claim 9, wherein the partially collapsed liner body comprises a series of pleats between the upper and lower ends thereof.

11. The bottle liner as in claim 10, wherein the liner body comprises a blanket of an inert gas between said infant formula and said seal.

12. The bottle liner as in claim 11, wherein the infant formula is contained within the liner in a substantial vacuum.

13. The bottle liner as in claim 9, wherein said infant formula is sterilized.

14. The bottle liner as in claim 9, wherein the infant formula is in the form of a powder, liquid concentrate or ready-to feed.

15. The bottle liner as in claim 14, wherein the infant formula is sterilized.

16. A package comprising a sealed container, and a plurality of ready-to-use baby bottle liners as in any one of claims 1-15 within said container.

17. The package of claim 16, wherein the sealed container is formed of an oxygen barrier film.

18. The package of claim 17, wherein the container contains an inert atmosphere.

19. The package of claim 18, wherein the inert atmosphere is nitrogen, argon and/or carbon dioxide.

20. A method of making ready-to-use sealed baby bottle liner having a premeasured amount of infant formula contained therein comprising the steps of:
(i) providing a baby bottle liner having a flaccid liner body with a closed bottom end and an open top end, and a self-supporting annular flange at the open top end thereof;
(ii) introducing a premeasured amount of infant formula into the liner body under an inert atmosphere; and then
(iii) sealing the open top end of the liner body to thereby form a sealed baby bottle liner having a premeasured amount of infant formula contained therein.

21. The method of claim 20, further comprising (iv) sterilizing the infant formula.

22. The method of claim 21, wherein step (iv) is practiced by subjecting the sealed liner body to irradiation for a time sufficient to sterilize the premeasured amount of infant formula contained therein.

23. The method of claim 22, wherein the irradiation is gamma or electron beam irradiation.

24. The method of claim 20, further comprising (iv) partially collapsing the flaccid liner body.

25. The method of claim 21, wherein step (iv) is practiced prior to step (ii).

26. The method of claim 21, wherein step (iv) is practiced after step (ii).

27. The method of claim 17, wherein the inert atmosphere is nitrogen, argon and/or carbon dioxide.

28. A method of making a package comprising placing a plurality of ready-to-use baby bottle liners as in any one of claims 1-12 within a container, and thereafter sealing the container.

29. The method of claim 25, which comprises placing the plurality of ready-to-use baby bottle liners within the container in an inert atmosphere.

30. The method of claim 26, wherein the inert atmosphere is nitrogen, argon and/or carbon dioxide.
